(19) United States
(12) Patent Application Publication
(10) Pub. No.: US 2024/0167709 A1
(43) Pub. Date: May 23, 2024

(54) SYSTEM AND METHOD FOR COMMUNICATION OF DAMPER POSITION OF A SAFETY DAMPER

(71) Applicant: Air Distribution Technologies IP, LLC, Milwaukee, WI (US)

(72) Inventors: Kent S. Maune, Independence, MO (US); Timothy A. Vogel, Independence, MO (US)

(21) Appl. No.: 18/513,414

(22) Filed: Nov. 17, 2023

Related U.S. Application Data
(60) Provisional application No. 63/427,750, filed on Nov. 23, 2022.

(51) Int. Cl. F24F 11/35; A62C 2/12; F24F 13/14

(52) U.S. Cl. CPC F24F 11/35; A62C 2/12; F24F 13/1426; F24F 2013/1433

(57) ABSTRACT

A damper (e.g., a safety damper) includes a sensor configured to provide a damper blade position signal indicative of a position of one or more damper blades and a communication interface configured to provide a damper identification and a damper blade position information associated with the damper blade position signal at periodic intervals or in response to a change in position. The damper identification and damper position information can be provided to fire safety equipment, another damper, or a safety panel.

### CROSS-REFERENCE TO RELATED PATENT APPLICATIONS

This application claims the benefit of and priority to U.S. Provisional Application No. 63/427,750, filed Nov. 23, 2022, the entire disclosure of which is incorporated by reference herein. This application is also related to U.S. Pat. Nos. 10,982,876, 10,415,847, and 9,395,099, all of which are hereby incorporated by reference in their entireties.

### FIELD OF THE INVENTION

The present disclosure relates to a damper position communication system and/or communication method for a safety damper or louver (e.g., a fire damper, a smoke damper, etc.).

### BACKGROUND

Dampers and louvers are used in heating, ventilating or air conditioning (HVAC) systems and life safety systems in buildings. Certain dampers and louvers maintain building pressurization, prevent the spread of fire or smoke, and prevent water penetration during a tropical storm or hurricane. Devices installed in certain locations often require operational certification prior to building occupancy. The International Building Code (IBC), along with the international Fire Code (IFC) and National Fire Protection Agency (NFPA), typically require initial inspection and ongoing inspections on a specified schedule after building occupancy. Certain existing methods of testing requires manual operation at the physical product location which may be inaccessible or difficult to access after the building is complete. Such applications often require hard wiring a test switch to every product, or wiring to a control network wired to a central control system. Fire, smoke and combination fire/smoke dampers are used protect life and limit property loss during a life safety event. A fire/smoke damper is used with a building air handling system as a prevention device for the spread of fire and smoke. Fire/smoke dampers may be designed to meet or exceed Underwriters Laboratories (UL) UL555, UL555C, UL555S, National Fire Protection Association, and California State Fire Marshal requirements in walls, ceilings, and floors. In general, these codes and standards require dampers that are able to stop the passage of flames for a period of 1½ or 3 hours and the leakage of smoke for up to 177° C. (350° F.) in smoke-laden air.

Life safety dampers differ from common commercial control dampers in their overall design and materials of construction, mainly through use of high temperature seals. Life safety dampers are also subject to additional testing not required of non-life safety dampers.

### SUMMARY

Some embodiments relate to a damper (e.g., a safety damper). The damper includes a sensor configured to provide a damper blade position signal indicative of a position of one or more damper blades and a communication interface configured to provide a damper identification and damper blade position information associated with the damper blade position signal at periodic intervals. The damper identification and damper position information is provided to fire safety equipment, another damper, or a safety panel.

In some embodiments, the communication interface is configured to communicate wirelessly. In some embodiments, the communication interface is configured to communicate via a mesh network. In some embodiments, the mesh network is coupled to a safety panel or life safety manager by a wired connection. In some embodiments, the wired connection is the only connection from the safety panel to the mesh network. The safety panel is a fire safety panel in communication with fire safety equipment (e.g., fire dampers, smoke dampers, sprinkler systems, and/or a smoke detectors) in some embodiments. In some embodiments, the damper further includes a relay circuit, and the communication interface is integrated with the relay circuit.

In some embodiments, the periodic basis is adjustable based upon a message received by the communication interface. In some embodiments, the periodic basis is every 10 seconds or less. In some embodiments, the communication interface is configured to provide the damper identification and the damper blade position information to the safety panel for use in alarm generation.

Some embodiments relate to a safety system. The safety system includes a fire panel and a smoke or fire damper. The smoke or fire damper includes one or more blades configured to regulate airflow, an actuator configured to move the one or more blades between a first position and a second position, a sensor configured to provide a damper blade position signal indicative of the first position or the second position of the one or more damper blades, and a communication interface. The communication interface is configured to provide a damper identification and damper blade information related to the damper blade position signal in response to a change of the one or more blades from the first position or the second position to panel.

In some embodiments, the sensor includes a switch contact configured to indicate the first position or the second position of the blade. In some embodiments, the communication interface is configured to communicate wirelessly. In some embodiments, the fire panel uses the damper blade information to provide an alarm. In some embodiments, the damper is a fire damper comprising a fusible link.

In some embodiments, the damper is a first damper of a number of dampers, and the communication interface is a component of a mesh network wirelessly connecting the dampers.

Some embodiments relate to a method of operating a safety system. The method includes providing a damper state of a fire or smoke damper via electronic communication to a fire panel. The method also includes using by the fire panel the damper state to provide an alarm.

In some embodiments, the damper includes one or more blades configured to regulate airflow, a switch contact configured to indicate the damper state based upon a position of the one or more blades, and an actuator configured to move the one or more blades.

In some embodiments, the method further includes providing the damper state from a first damper to a second damper, wherein the damper state is provided in a message comprising an identification of the smoke damper or the fire damper. In some embodiments, the electronic communication is wireless communication.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a block diagram of a safety system in accordance with some exemplary embodiments;

FIG. 2 is a block diagram of the safety system illustrated in FIG. 1 communicating using a mesh network in accordance with some exemplary embodiments;

FIG. 3 is a perspective view schematic drawing of a safety damper for use in the safety system illustrated in FIG. 1 in accordance with some exemplary embodiments;

FIG. 4 is a perspective view schematic drawing of the safety damper illustrated in FIG. 3 installed on a duct in accordance with some exemplary embodiments;

FIG. 5 is a more detailed schematic drawing of a wireless damper interface for the safety damper illustrated in FIG. 3 in accordance with some exemplary embodiments;

FIG. 6 is an electrical schematic drawing of the safety damper in accordance with some exemplary embodiments; and

FIG. 7 is a cross sectional view schematic drawing of a fire damper for use in the safety system illustrated in FIG. 1 in accordance with some exemplary embodiments.

### DETAILED DESCRIPTION

A communication system provides damper position sensed at a damper to a safety panel in some embodiments. The communication system provides the damper position (e.g., damper state) to a central location or safety panel in some embodiments. The communication can occur via a wire or an indirect communication mesh. In some embodiments, the indirect mesh includes fire safety devices (e.g., fire response devices) having wireless modules or circuits. The fire safety devices can include smoke dampers, fire dampers, smoke detectors, sprinkler systems, and/or strobe lights. The term damper refers to a damper or louvre as used herein.

Advantageously, the systems and methods provide a unified fire control where fire detection, fire suppression and life safety equipment act together for a best or more suitable response against a hazard situation in some embodiments. In some embodiments, the fire panel uses the position signal to make an alarm determination. The alarm determination can include a fire alarm. The alarm determination can be made using the position signal and smoke sense signal, or other first safety signal in some embodiments.

In some embodiments, the communication module or circuit is a communication line card provided with a relay circuit associated with the damper. Communication modules can be provided with fire safety devices (e.g., fire dampers, sprinkler systems, smoke detectors, and strobe lights). The communication circuit and the relay are provided in an integrated unit distinct from the damper in some embodiments. In some embodiments, the damper position or status is sensed via contact switches integral with the smoke damper and coupled top the relay. In some embodiments, the damper includes blades that are positioned in an opened or closed state sensed by a position sensor.

In some embodiments, the communication circuit communicates via a wired connection (e.g., via power wires for the relay). The communication circuit can provide data indicating the location and identity (damper type, damper address, building location, etc.) of the fire damper or smoke damper with the position information. When indirect communication is utilized, display of all devices communicating by mesh network indirectly can be provided on the fire panel including damper states. Identification stored in the communication unit can be transmitted and display and include building name or floor(s) for example.

The communication unit or module is located next to the device (e.g., a critical application device) and is wired to the electrical circuit of the actuator. The communication module includes a wireless transceiver for communication, switch contacts to indicate blade position, smoke alarm contact, and a relay to position the connected actuator.

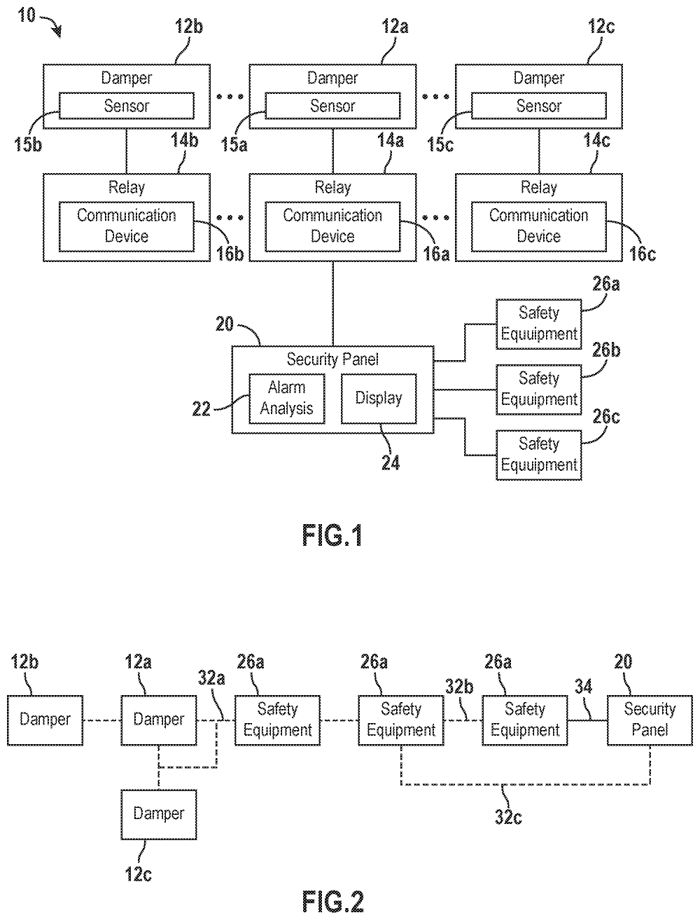

With reference to FIG. 1, a safety system 10 (e.g., a fire safety system) includes one or more dampers 12A-C, one or more associated relay circuits 14 A-C, a central, security, or safety panel 20 (e.g., fire panel), and fire safety equipment 26A-C. Dampers 12A-C, one or more associated relays circuits 14 A-C, safety panel 20, fire safety equipment 26A-C, and fire safety equipment 26 are in communication with each other via wires or wireless networks (e.g., a mesh network).

Dampers 12A-C are smoke or fire dampers in some embodiments. Dampers 12A-C includes sensors 15A-C for sensing a position of the damper (e.g., the blades of the damper being in an open or closed state or other position). The sensors 15A-C provide the damper position signal as an electronic signal. Sensors 15A-C can be contact sensors associated with providing power to indicator lights on dampers 12A-C. In some embodiments, each of respective dampers 12A-C are associated with a relay circuit 14A-C electrically coupled via wires to the dampers 12A-C.

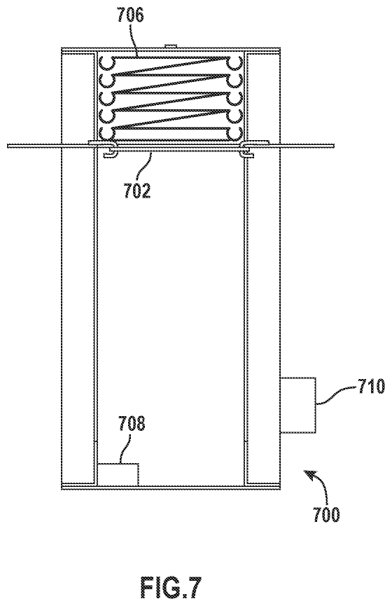

Smoke dampers can include a smoke sensor or detector so that the smoke damper can be opened or closed when smoke is detected. Fire dampers can include a fusible link (see FIG. 7) that when melted due to heat from a fire, opens or closes blades of the damper. Dampers 12A-C are flood or other safety dampers in some embodiments. The relay circuits 14A-C are coupled to and provide and disconnect power to dampers 12A-C and receive damper position or state from sensors 15A-B, respectively.

Relay circuits 14A-C include communication circuits 16A-C, respectively. In some embodiments, communication circuits 16A-C are integrated or combined with relay circuits 14A-C and powered via the relay circuits 14A-C. Communication interfaces or circuits 16A-C can also be stand-alone units or integrated with dampers 12A-C in some embodiments. The relay circuits 14A-C include solid state or electromechanical relays and are hardwired to the dampers 12A-C (e.g., sensors 15A-C or associated actuators) in some embodiments. The relays within relay circuits 14A-C can be used to provide power to an actuator that opens or closes the damper 12A-C. In some embodiments, relay circuits 14A-C and/or communications circuits are provided as part of smoke detectors associated with a smoke damper. Relay circuits 14A-C also serve to remove power from a damper 12A-C in the event of a fire, smoke, or other alarm condition.

Communication circuits 16A-C can include transceivers for communicating via wired or wireless mediums. Communications circuits 16A-C can be or include wired or wireless communications interfaces (e.g., jacks, antennas, transmitters, receivers, transceivers, wire terminals, etc.) for conducting data communications with devices in system 10 or other external systems or devices, according to some embodiments. Communication circuits 16A-C are implemented as a line card in relay circuits 14A-C in some embodiments. In some embodiments, communication circuits 16A-C monitor blade position (e.g. open or closed state) and provide the damper identification and damper position in response to a change in state. In some embodiments, communication circuits 16A-C monitor blade position (e.g. open or closed state) and provide the damper identification and damper position periodically such as every minute or less, every 10 seconds or less, etc. (e.g., every minute, every 10 seconds, every 5 seconds, etc.).

In some embodiments, communications via communication circuits 16A-C can be direct communications (e.g., local wired or wireless communications) or via a communications network (e.g., a WAN, the Internet, a cellular network, etc.). For example, communications circuits 16A-C can include an Ethernet or building automation control network (BACnet) card and port for sending and receiving data via an Ethernet-based or BACnet-based communications link or network. In another example, circuits 16A-C can include a Wi-Fi transceiver for communicating via a wireless communications network. In yet another example, circuits 16A-C can include cellular or mobile phone communications transceivers. Communication circuits 16A-C may communicate via a variety of protocols, (e.g., Ethernet protocol, building automation and control network (BACnet) protocol, 802.11 protocols, ZigBee protocols, LONTalk protocols, 5G protocols, etc.). Communication circuits 16A-C are configured to receive the position signal and provide the position signal and information about dampers 12A-C to safety panel 20 along with identification information in some embodiments.

Safety panel 20 is a safety device for use in buildings. Safety panel 20 can be an addressable panel in some embodiments. Safety panel 20 is configured to set into motion a number of tasks that could save lives and minimize property damage according to sensed or input criteria in some embodiments. In some embodiments, safety panel 20 is a fire control panel including an alarm analysis circuit 22 and a display 24. Safety panel 20 is configured to call the fire department, activate the building's sprinkler system in response to signals from safety equipment 26A-C. Safety equipment 26A-C can include any number of smoke detectors, carbon monoxide detectors, the fire sprinkler systems, a manual call points, pull switches, etc. Upon detection of a fire or other hazard using alarm analysis circuit 22, safety panel 20 is configured to trigger alarms, lights, dampers, safety equipment 26A-C, etc. Safety equipment 26A-C can include any number of smoke detectors, carbon monoxide detectors, the fire sprinkler systems, a manual call points, pull switches, etc. Safety equipment 26A-C can include communication circuits similar to communication circuits 16A-C.

In some embodiments, the time period for periodic communications is adjusted by providing a message from safety panel 20 to communication circuits 16A-C in some embodiments. For example, a message may be provided communication circuits 16A-C to increase the frequency of periodic communications in response to other sensor data or analysis by alarm analysis circuit 22. If other alarms are issued or other sensors (e.g., smoke detectors) indicate a hazardous condition), the interval for communications may be increased so that damper position data is received more frequently in some embodiments. Further, if alarm analysis circuit 22 receives an indication that a damper 12A-C is opened or closed, the message may be sent to other dampers 12A-C to report damper position status or increase the frequency of communication in some embodiments.

In some embodiments, safety panel 20 can initiate a test sequence through communication circuits 16A-C. The safety panel 20 can provide a command addressed to a particular damper 12A-C to move blades of the dampers 12A-C and receive a message indicating a position of the dampers 12A-C. In some embodiments, actuation timing of dampers 12A-C actuator is determined. Advantageously, the safety panel 20 is configured to transmit the signals to communication circuits 16A-C for operational verification of the dampers 12A-C and associated actuators without requiring a portable device. The safety panel 20 is configured to sort dampers 12A-C by any desired category including by building name or floor(s) for example on display 24. When testing is complete, safety panel 20 provides a test report by with time stamp and “PASS” or “FAIL” message for each interrogated damper 12A-C in some embodiments.

In some embodiments, safety panel 20 can display the position or state of dampers 12A-C on display 24. Display 24 can be a liquid crystal display. Display 24 can provide indicia of alarms and information about dampers 12A-C and safety equipment 26A-C. The test report is provided on display 24 in some embodiments.

Safety panel 20 as well as communication circuits 16A-C can include one or more processors and electronic hardware communicably coupled to one or more memory or memory devices. The one or more processors may be embodied in various ways. The one or more processors may be implemented as one or more general-purpose processors, application specific integrated circuits (ASICs), field programmable gate arrays (FPGAs), digital signal processors (DSPs), or other suitable electronic data processing components structured to execute instructions provided by memory.

Safety panel 20 can include communication circuits similar to communication circuits 16A-C. Alarm analysis circuit 22 can use information from dampers 12A-C to ascertain whether an alarm should be provided. For example, if a fire damper is in an open state or a closed state due to a melted fuse wire, alarm analysis circuit 22 can issue an alarm or a notification on display 24. In some embodiments, the alarm analysis circuit 22 considers information from other safety equipment 24A-C as well as dampers 12A-C before issuing the alarm (e.g., smoke detectors, etc.). Similarly, if a smoke damper is in an open state or a closed state due to detection of smoke, alarm analysis circuit 22 can issue an alarm or a notification on display 24. In some embodiments, the alarm analysis circuit 22 considers information from other safety equipment 26A-C and other dampers 12A-C. Advantageously, the sensing and use of damper position provides additional data or redundant data that may be used by alarm analysis circuit 22 to indicate an alarm condition or to increase certainty associated with an alarm.

With reference to FIG. 2, system 10 is configured for communication among one or more dampers 12A-C, a safety panel 20 (e.g., fire panel), fire safety equipment 26A-C, and fire safety equipment 26 via the wireless mesh (e.g., via wireless links 32A-C). The use of one or more dampers 12A-C, a safety panel 20 (e.g., fire panel), and safety equipment 26A-C as communicating nodes allows a number of nodes to be distributed throughout the building. Safety panel 20 can be connected by wire to any of one or more dampers 12 A-C, one or more associated relay circuits14 A-C, fire safety equipment 26A-C, and fire safety equipment 26 (via wired link 34). In some embodiments, the last link to safety panel 20 is a wired link (e.g., link 34) and safety panel 20 does not communicate wirelessly. In some embodiments, a building includes more than one safety panel 20.

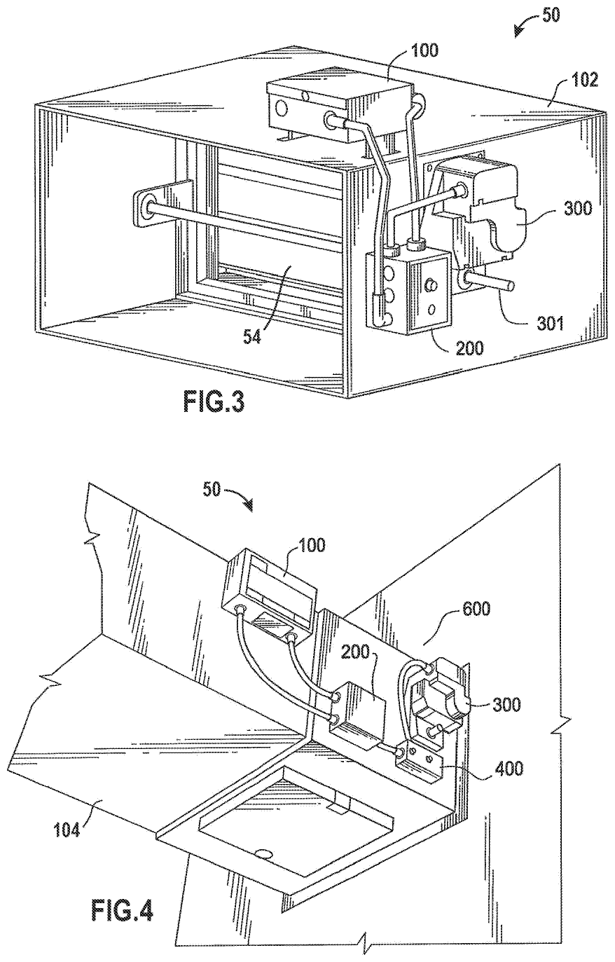

With reference to FIG. 3, a damper 50 can include a damper sleeve 102. Damper 50 can be used as any of dampers 12A-C and includes vanes, fins or blades 54. Damper 50 includes blades 54, a communication interface 100, a junction box 200, an actuator 300, and a rod 301. Damper 50 can be a safety damper such as a smoke damper or fire damper in some embodiments. Damper 50 can be a static damper which uses springs or gravity to move of blades and does not include an actuator 300.

Interface 100 is mounted to damper sleeve 102 or other suitable mounting surface. Interface 100 includes a communication circuit similar to communication circuits 16A-C (FIG.1) and is connected to junction box 200 which contains a switch package 400 (FIG. 4) that includes contacts and power terminations associated with a sensor similar to sensors 15A-C (FIG.1). Junction box 200 can include a relay circuit, such as, relay circuits 14A-C (FIG.1), and switch package 400 can be provided in junction box 200 or interface 100 in some embodiments.

Junction box 200 is connected to a damper actuator 300. Junction box 200 may be a pass through for power and switch field connections when the applicable code requires a separate box for such terminations, or it may include internal switch components and/or thermal links. When damper actuator 300 is equipped with internal switches, junction box 200 may not be required. When junction box 200 is not required, power and switch wiring may terminate directly to the enclosure of interface 100 in some embodiments.

Actuator 300 is configured to drive a rod 301 to open and close blades 54 of damper 50. Actuator 300 can be powered by the relay circuit in junction box 200 and can include solenoids, motors, and other motive devices for driving rod 301.

With reference to FIG. 4, damper 50 is installed on a duct 104. Switch package 400 contains contact switches that send a signal when the damper 50 has blades or other elements are in the open or closed position. Switch package 400 can serve as any of sensors 15A-C (FIG. 1). Contact switches may also be included in the damper actuator 300. An access door can be provided in the duct 104 for accessing the interior of the duct 104 as well as the blades 54.

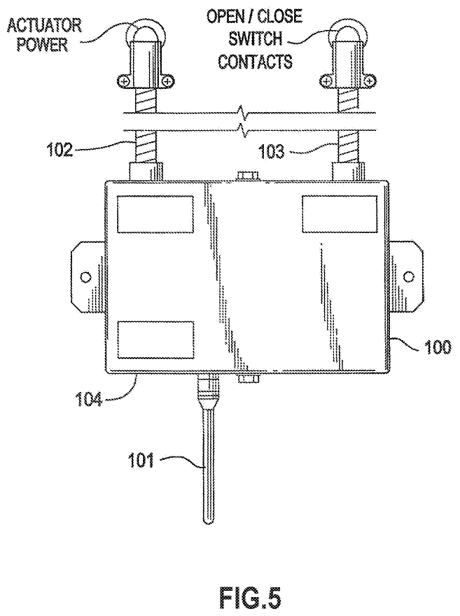

With reference to FIG. 5, interface 100 includes an antenna 101 for receiving radio frequency (RF) signals and providing RF signals to and from safety panel 20 or security or safety equipment 26A-C (FIG. 1). Actuator power is connected to actuator 300. Switch leads 103 are connected to the damper switch package 400 (FIG. 4) or to the switches included in the actuator 300 (FIG. 4). Building power is connected to the interface 100. Each interface 100 is encoded with a unique address that identifies the particular damper 50. Each interface 100 can also include information such as damper type, location, etc.

Interface 100 is configured for automatic synchronized wired or wireless communication. The system frequency is selected as may be appropriate for the system or installation or both, including but not limited to 60 GHz, 6 GHZ, 5.9 GHZ, 5 GHZ, 4.9 GHZ, 3.6 GHz, 2.4 GHz, 915 MHz, 902 MHz, 868.3 MHz or 315 MHz. When the interface 100 incorporates indirect communication, data is transmitted longer distances by “hopping” information between other interfaces or communication circuits 16A-C associated with safety equipment 26A-C (e.g., fire safety equipment) and safety panel 20 (FIG. 2). For example, mesh network technology based on 802.15.4-2011-IEEE Standard for local and metropolitan area networks—Part 15.4: Low-Rate Wireless Personal Area Networks (LR-WPANs) may be used.

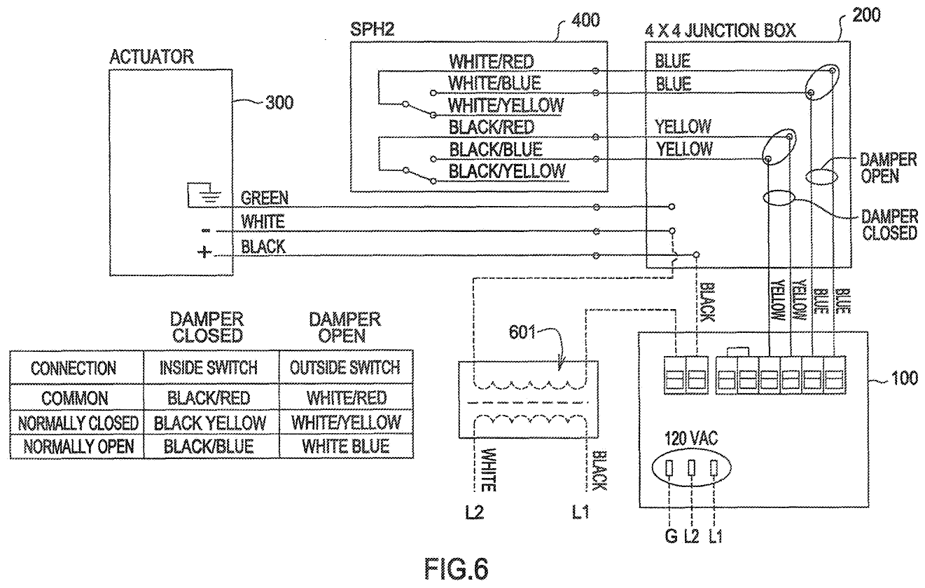

With reference to FIG. 6, interface 100 is connected to junction box 200. Junction box 200 is a pass through for switch and actuator field wiring. In some cases, junction box 200 may not be required. When the applicable code allows, the wiring from actuator 300 and position switches in switch package 400 may terminate inside interface 100. In other applications, when the actuator 300 is equipped with internal damper blade indication switches, the switch and power wires may terminate inside enclosure of the interface 100. Actuator power is provided by a 120/24 VAC transformer 601. In some embodiments potentiometers instead of position switches are used in switch package 400 to provide a less discrete indication of the position of blades 54 (FIG. 3).

With reference to FIG. 7, a fire damper 700 can be used as one or more of dampers 12A-C (FIG. 1). Fire damper 700 includes a fusible link 702 that holds blades 706 in an open or closed position which can be sensed by sensor 708. When the fusible link is melted or otherwise incapacitated, blades 706 move to the closed or open position (based upon configuration) due to the force of gravity, spring bias, or other force. When the sensor 708 indicates that a normally open damper is closed or a normally closed damper is open, it is an indication that fusible link 702 is melted and a fire event may be occurring near damper 700. Safety panel 20 (FIG. 1) can use this information including the location of fire damper 700 provided by communication circuit 710 (similar to communication circuits16A-C) to provide an alarm. Communication circuit 710 is battery powered in some embodiments.

The term circuit refers to a hardware circuit and also refers to one or more processors communicably coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations. The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A damper, comprising:
a sensor configured to provide a damper blade position signal indicative of a position of one or more damper blades; and
a communication interface configured to provide a damper identification and a damper blade position information associated with the damper blade position signal at periodic intervals to fire safety equipment, another damper, or a safety panel.

2. The damper of claim 1, wherein the communication interface is configured to communicate wirelessly.

3. The damper of claim 2, wherein the communication interface is configured to communicate via a mesh network.

4. The damper of claim 3, wherein the mesh network is coupled to the safety panel by a wired connection.

5. The damper of claim 4, wherein the wired connection is an only connection to the mesh network.

6 The damper of claim 5, wherein the safety panel is a fire safety panel and the fire safety equipment is a sprinkler system or a smoke detector.

7. The damper of claim 1, further comprising:
a relay circuit, wherein the communication interface is integrated with the relay circuit.

8. The damper of claim 1, wherein the periodic basis is adjustable based upon a message received by the communication interface.

9. The damper of claim 1, wherein the periodic basis is every 10 seconds or less.

10. The damper of claim 1, wherein the communication interface is configured to provide the damper identification and the damper blade position information to the safety panel for use in alarm generation.

11. A safety system, comprising:
a fire panel; and
a smoke or fire damper comprising:
one or more blades configured to regulate airflow;
an actuator configured to move the one or more blades between a first position and a second position;
a sensor configured to provide a damper blade position signal indicative of the first position or the second position of the one or more blades;
and
a communication interface configured to provide a damper identification and damper blade information related to the damper blade position signal in response to a change of the one or more blades from the first position or the second position to panel.

12. The safety system of claim 11, wherein the sensor comprises a switch contact configured to indicate the first position or the second position of the one or more blades.

13. The safety system of claim 11, wherein the communication interface is configured to communicate wirelessly.

14. The safety system of claim 11, wherein the fire panel uses the damper blade information to provide an alarm.

15. The safety system of claim 14, wherein the fire or smoke damper is a fire damper comprising a fusible link.

16. The safety system of claim 11, wherein the fire or smoke damper is a first damper of a plurality of dampers, and wherein the communication interface is a component of a mesh network wirelessly connecting the plurality of dampers.

17. A method of operating a safety system, the method comprising:
providing a damper state of a fire or smoke damper via electronic communication to a fire panel; and
using by the fire panel, the damper state to provide an alarm.

18. The method of claim 17, wherein the fire or smoke damper comprises:
one or more blades configured to regulate airflow;
a switch contact configured to indicate the damper state based upon a position of the one or more blades; and
an actuator configured to move the one or more blades.

19. The method of claim 17, further comprising:
providing the damper state from a first damper to a second damper, wherein the damper state is provided in a message comprising an identification of the fire or smoke damper.

20. The method of claim 17, wherein the electronic communication is wireless communication.
